(19) United States
(12) Patent Application Publication
(10) Pub. No.: US 2016/0266813 A1
(43) Pub. Date: Sep. 15, 2016

(54) STORAGE SUBSYSTEM TECHNOLOGIES

(71) Applicant: Robert Supnik, Carlisle, MA (US)

(72) Inventor: Robert Supnik, Carlisle, MA (US)

(73) Assignee: UNISYS CORPORATION, Blue Bell, PA (US)

(21) Appl. No.: 14/641,587

(22) Filed: Mar. 9, 2015

(51) Int. Cl. G06F 3/06

(52) U.S. Cl. CPC G06F 3/0608; G06F 3/0688; G06F 3/0655; G06F 3/0641

(57) ABSTRACT

A method for reading data is provided. The method comprises receiving, via a storage subsystem controller, over a fabric, a read command from a host device. The method further comprises locating, via the storage subsystem controller, over the fabric, based at least in part on the read command, read data in a flash main memory of a node device. The method also comprises facilitating, via the storage subsystem controller, an establishment of a remote direct memory access connection between the flash main memory of the node device and the host device over the fabric such that the read data is communicable from the flash main memory of the node device to the host device over the fabric.

### TECHNICAL FIELD

Generally, the present disclosure relates to computing. More particularly, the present disclosure relates to storage area networking.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure is concerned with. Further, nothing is disclaimed.

Flash memory is a type of non-volatile and rewritable data storage medium. Such memory is embodied in various ways, such as main memory, memory cards, Universal Serial Bus (USB) flash drives, solid-state drives, and other similar products. In storage area networking (SAN) field, flash memory is often used with storage subsystems, where the flash memory is embodied as solid state drives for data storage. In order to read or write data in such environment, a set of steps is performed.

For example, to read data, a host device sends a read command to a storage subsystem controller over a storage fabric, such as a Fibre Channel network. The controller, based on the read command, identifies which node device in a storage subsystem stores read data. Based on such identification, the controller sends a retrieve command to the node device over a backend intra-subsystem fabric, such as an InfiniBand® architecture/specification based network. In response, the node device instructs a solid state drive to read the read data into local memory of the node device, where the node device is operably coupled to the solid state drive. Subsequently, the node device copies the read data from the local memory of the node device to local memory of the controller over the backend intra-subsystem fabric. Then, the controller copies the read data to the host device over the storage fabric.

Similarly, for example, to write data, a host device sends a write command to a storage subsystem controller over a storage fabric, such as a Fibre Channel network. The controller, based on the write command, identification which node device in a storage subsystem will store write data and what location will be used for such storage. Based on such identification, the controller retrieves the write data from the host device and stores the write data in a local memory of the controller. Next, the controller sends a store command to the node device, as previously identified, over a backend intra-subsystem fabric, such as an InfiniBand® architecture/specification based network. Then, the controller copies the write data from the local memory of the controller to a local memory of the node device over the backend intra-subsystem fabric. Subsequently, the node device writes the write data to a solid state drive operably coupled to the node device. In some cases, for data redundancy, the write data can be written to multiple nodes.

Although such processes can be beneficial, a set of drawbacks exists. For example, the networking environment described above includes at least two fabrics, i.e., one for client-subsystem communication and one for intra-subsystem communication. Building and maintaining such environment is complicated and costly. Further, multiple memory-to-memory copies are performed to communicate data between the host device and the storage subsystem. In terms of network performance, such operations lead to longer latency and reduced bandwidth, which is inefficient.

Accordingly, there is a desire to improve efficiency of at least one of such processes, while simplifying SAN topology in a cost-effective manner.

### SUMMARY

The present disclosure at least partially addresses at least one of the above. However, the present disclosure can prove useful to other technical areas. Therefore, the claims should not be construed as necessarily limited to addressing any of the above.

According to an example embodiment of the present disclosure a method for reading data is provided. The method comprises receiving, via a storage subsystem controller, over a fabric, a read command from a host device. The method further comprises locating, via the storage subsystem controller, over the fabric, based at least in part on the read command, read data in a flash main memory of a node device. The method also comprises facilitating, via the storage subsystem controller, an establishment of a remote direct memory access connection between the flash main memory of the node device and the host device over the fabric such that the read data is communicable from the flash main memory of the node device to the host device over the fabric.

According to another example embodiment of the present disclosure a system for reading data is provided. The system comprises a fabric. The system further comprises a host device operably coupled to the fabric. The system also comprises a storage subsystem controller operably coupled to the fabric. The storage subsystem controller is configured to receive a read command from the host device over the fabric. The system additionally comprises a node device comprising a flash main memory. The node device is operably coupled to the fabric. The storage subsystem controller is configured to locate read data in the flash main memory of the node device over the fabric based at least in part on the read command. The storage subsystem controller is configured to facilitate an establishment of a remote direct memory access connection between the flash main memory of the node device and the host device over the fabric such that the read data is communicated from the flash main memory of the node device to the host device over the fabric.

According to yet another example embodiment of the present disclosure a computer readable storage device is provided. The storage device stores a set of instructions executable via a processing circuit to implement a method of reading data. The method comprises receiving, via a storage subsystem controller, over a fabric, a read command from a host device. The method further comprises locating, via the storage subsystem controller, over the fabric, based at least in part on the read command, read data in a flash main memory of a node device. The method also comprises facilitating, via the storage subsystem controller, an establishment of a remote direct memory access connection between the flash main memory of the node device and the host device over the fabric such that the read data is communicable from the flash main memory of the node device to the host device over the fabric.

### BRIEF DESCRIPTION OF THE DRAWINGS

The accompanying drawings illustrate example embodiments of the present disclosure. Such drawings are not to be construed as necessarily limiting the disclosure. Like numbers and/or similar numbering scheme can refer to like and/or similar elements throughout.

FIG. 1 shows an example schematic of a network topology according to the present disclosure.

FIG. 2 shows an example schematic of a computer according to the present disclosure.

FIG. 3 shows a flowchart of an example embodiment of a method for reading data according to the present disclosure.

FIG. 4 shows a flowchart of an example embodiment of a method for writing data according to the present disclosure.

### DETAILED DESCRIPTION

The present disclosure is now described more fully with reference to the accompanying drawings, in which example embodiments of the present disclosure are shown. The present disclosure may, however, be embodied in many different forms and should not be construed as necessarily being limited to the example embodiments disclosed herein. Rather, these example embodiments are provided so that the present disclosure is thorough and complete, and fully conveys the concepts of the present disclosure to those skilled in the relevant art.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

As used herein, the term “about” and/or “substantially” refers to a +/−10% variation from the nominal value/term. Such variation is always included in any given value/term provided herein, whether or not such variation is specifically referred thereto.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

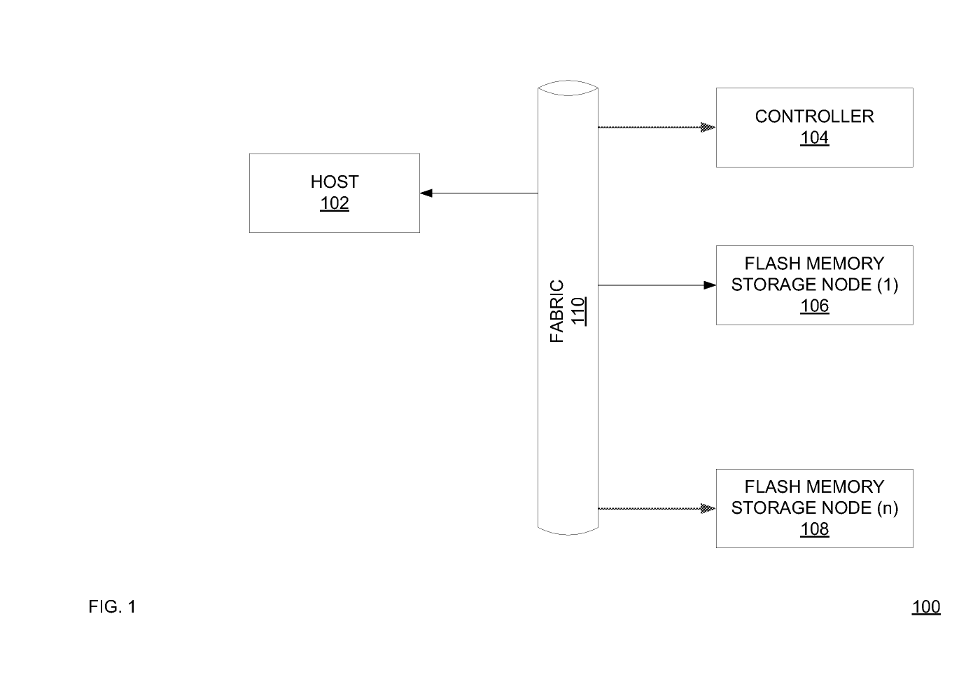

FIG. 1 shows an example schematic of a network topology according to the present disclosure. A network topology 100 comprises a host device 102, a storage subsystem controller 104, a flash memory storage node device 106, a flash memory storage node device 108, and a fabric 110 to which the host device 102, the controller 104, the storage node device 106, and the storage node device 108 are operably coupled. Note that any number of host devices 102, controllers 104, and node devices 106, 108 can be operably coupled to the fabric 110, whether directly or indirectly, whether in a wired or a wireless manner, in any type of correspondence, such as one-to-one, one-to-many, many-to-one, and many-to-many. In other embodiments, the topology 100 lacks the node device 108.

The host device 102 comprises a hardware processor and a memory operably coupled to the processor, such as a main memory, for instance random access memory (RAM), which can be flash memory. For example, the host device 102 is a server computer running a software application. Note that the host device 102 can comprise at least one input device, such as a keyboard, and at least one output device, such as a display. The host device 102 is operably coupled to the fabric 110, whether directly or indirectly, whether in a wired or a wireless manner, such as via a switched fabric adapter, a network card, or a network adapter. Note that the host device 102 can also be operably coupled to another fabric or another device, whether directly or indirectly, whether in a wired or a wireless manner.

The host device 102 supports a remote direct memory access (RDMA) technique, such as via inclusion of a RDMA technique compliant adapter, which in some embodiments can transfer data at a rate of about 40 Gigabit per second. Note that the RDMA technique can include a third party orchestrated RDMA technique. The RDMA technique enables a direct memory access between a first main memory of a first computer and a second main memory of a second computer without involving a first hardware processor and a first operating system kernel of the first computer and a second hardware processor and a second operating system kernel of the second computer. For example, such functionality can be enabled via zero-copy network operations where a network adapter directly transfers data between the main memories of the computers, which effectively eliminates a need for work via the processors, processor caches, or context switches, while data transfers occur in parallel with other operations of the computers. One benefit of such technique is shorter latency and increased bandwidth. Note that the RDMA technique can be Ethernet-based. Also, note that other types of high performance computing interconnects can be used as well, such as RDMA over Converged Ethernet (RoCE).

The controller 104 comprises a hardware processor and a memory operably coupled to the processor, such as a main memory, for instance RAM, which can be flash memory. For example, the controller 104 is a server computer running a software application. Note that the controller 104 can comprise at least one input device, such as a keyboard, and at least one output device, such as a display. The controller 104 is operably coupled to the fabric 110, whether directly or indirectly, whether in a wired or a wireless manner, such as via a switched fabric adapter, a network card, or a network adapter. Note that the controller 104 can also be operably coupled to another fabric or another device, whether directly or indirectly, whether in a wired or a wireless manner. The controller 104 can be configured to support the RDMA technique, such as via inclusion of a RDMA technique compliant adapter, which in some embodiments can transfer data at a rate of about 40 Gigabit per second. Also, note that the controller 104 can be configured to support the Ethernet-based RDMA technique or other types of high performance computing interconnects, such as RoCE.

The node device 106 comprises a hardware processor and a memory operably coupled to the processor, such as a main memory, for instance RAM, which can be flash memory. For example, the node device 106 is a server computer running a software application. For example, the node device 106 can be operably coupled to a solid state disk, whether directly or indirectly, whether in a wired or a wireless manner. Note that the node device 106 can comprise at least one input device, such as a keyboard, and at least one output device, such as a display. The node device 106 is operably coupled to the fabric 110, whether directly or indirectly, whether in a wired or a wireless manner, such as via a switched fabric adapter, a network card, or a network adapter. Note that the node device 106 can also be operably coupled to another fabric or another device, whether directly or indirectly, whether in a wired or a wireless manner. The node 106 is configured to support the RDMA technique, such as via inclusion of a RDMA technique compliant adapter, which in some embodiments can transfer data at a rate of about 40 Gigabit per second. Also, note that the node device 106 can be configured to support the Ethernet-based RDMA technique or other types of high performance computing interconnects, such as RoCE.

The node device 108 comprises a hardware processor and a memory operably coupled to the processor, such as a main memory, for instance RAM, which can be flash memory. For example, the node device 108 is a server computer running a software application. Also, for example, the node device 108 can be operably coupled to a solid state disk, whether directly or indirectly, whether in a wired or a wireless manner. Note that the node device 108 can comprise at least one input device, such as a keyboard, and at least one output device, such as a display. The node device 108 is operably coupled to the fabric 110, whether directly or indirectly, whether in a wired or a wireless manner. Note that the node device 108 can also be operably coupled to another fabric or another device, whether directly or indirectly, whether in a wired or a wireless manner, such as via a switched fabric adapter, a network card, or a network adapter. Also, note that the node device 106 and the node device 108 can be identical or different from each other in computer architecture. Further, note that any number of node devices 108 can be operably coupled to the fabric 110. The node 108 can be configured to support the RDMA technique, such as via inclusion of a RDMA technique compliant adapter, which in some embodiments can transfer data at a rate of about 40 Gigabit per second. Also, note that the node device 108 can be configured to support the Ethernet-based RDMA technique or other types of high performance computing interconnects, such as RoCE.

The fabric 110 comprises a set of hardware, which allow for sharing of resources or information between at least one of the host device 102, the controller 104, the node device 106, and the node device 108. For example, the fabric 110 can comprise a scalable switched fabric network topology, such as an InfiniBand® architecture/specification network interconnect link, which comprises hardware, such as a switch or a fiber optic cable. The fabric 110 can be configured to send data serially and can carry a set of channels of data concurrently in a multiplexing signal, where the channels are created via attaching a host channel adapter and a target channel adapter through a switch. The sharing of resources or information can be direct and/or indirect. The fabric 110 can be wired and/or wireless. The fabric 110 can allow for communication over short and/or long distances, whether encrypted and/or unencrypted. The fabric 110 can be operated, directly and/or indirectly, by and/or on behalf of one and/or more entities, irrespective of any relation to contents of the present disclosure. The fabric 110 supports the RDMA technique, the Ethernet-based RDMA technique or other types of high performance computing interconnects, such as RoCE.

In one method of operation, multiple servers, such as the node devices 106-108, are equipped with flash memory, which sits in a normal memory hierarchy and is directly addressable by software, are attached to a high-speed fabric, such as the fabric 110, to form a storage subsystem. The storage subsystem transfers data over the high-speed fabric directly to/from client systems from/to the flash memory using the RDMA technique. The flash memories in the storage subsystem servers comprise an available storage pool.

More particularly, client systems, such as the host device 102, and the storage subsystem complex, such as the controller 104 and the node device 106, are tied together with a high-speed fabric that supports RDMA and third-party RDMA (DMA transfers between two nodes that are orchestrated by a third node). InfiniBand® architecture/specification network interconnect link is an example of a fabric meeting this requirement, but any fabric with the required capabilities can be used. The servers comprising the storage system have large amounts of flash memory directly accessible as part of the memory hierarchy. This is in contrast to solid-state drives or input-output (IO) bus based flash memory cards, which hide flash memory behind a controller to appear as an IO device. As described herein, the flash memory is in the memory hierarchy and can be addressed as memory for many purposes, including RDMA. The storage subsystem can include at least three servers: one to function as a controller, and two to function as storage containers (for redundancy). Additional controller(s) and storage container(s) can be used for greater capacity and redundancy.

Accordingly, in some embodiments, to read data, the host device 102 requests a read by sending a command packet to the storage subsystem controller 104. The storage subsystem controller 104 identifies which of the node devices 106-108 in the topology 100 has a desired storage. The storage subsystem controller 104 sets up a third-party RDMA request between the node devices 106-108 and the host device 102. Alternately, if the fabric 110 does not allow third-party RDMA, then the storage subsystem controller 104 can send a command to the node devices 106-108 to perform the transfer. Note that no data copies are required. The data is transferred directly from the flash memory in the node devices 106-108 to the host device 102, without intermediate copies.

Likewise, in some embodiments, to write data, the host device 102 requests a write by sending a command packet to the storage subsystem controller 104. The storage subsystem controller 104 identifies which of the node devices 106-108 in the topology 100 will store new data, and which location will be used to store the new data. The storage subsystem controller 104 sets up a third-party RDMA request between the host device 102 and the node device 106-108. Alternately, if the fabric 110 does not allow for the third-party RDMA, then the storage subsystem controller 104 can send a command to the storage node 106-108 to perform the transfer. No data copies are required. The data is transferred directly from the host device 102 memory to the flash memory in the node device 106-108, without intermediate copies. The new data can be written to multiple nodes, for redundancy. Note that because there is no intermediate controller between the flash memory and the node devices 106-108, flash-specific maintenance issues, such as wear leveling, are performed by the storage subsystem controller 104, such as when the storage subsystem controller 104 identifies which of the node devices 106-108 in the topology 100 will store new data, and which location will be used to store the new data.

Therefore, by eliminating at least two intermediate copies (flash drive to storage node and storage node to controller for read; controller to storage node and storage node to flash drive for write), the topology 100 enables reading and writing with lower latency than current flash-based storage subsystems. By using the much higher bandwidth of a main memory bus, rather than a narrow bandwidth of solid-state disk interfaces or the IO bus, the topology 100 enables reading and writing with higher throughput than current flash-based storage subsystems, limited only by a performance of the fabric 110 itself. Also, note that in order to enable flash memory hot swapping, while accommodating for redundancy, mirroring can be performed as a unit of failure is an entire node device rather than an individual solid-state disk drive.

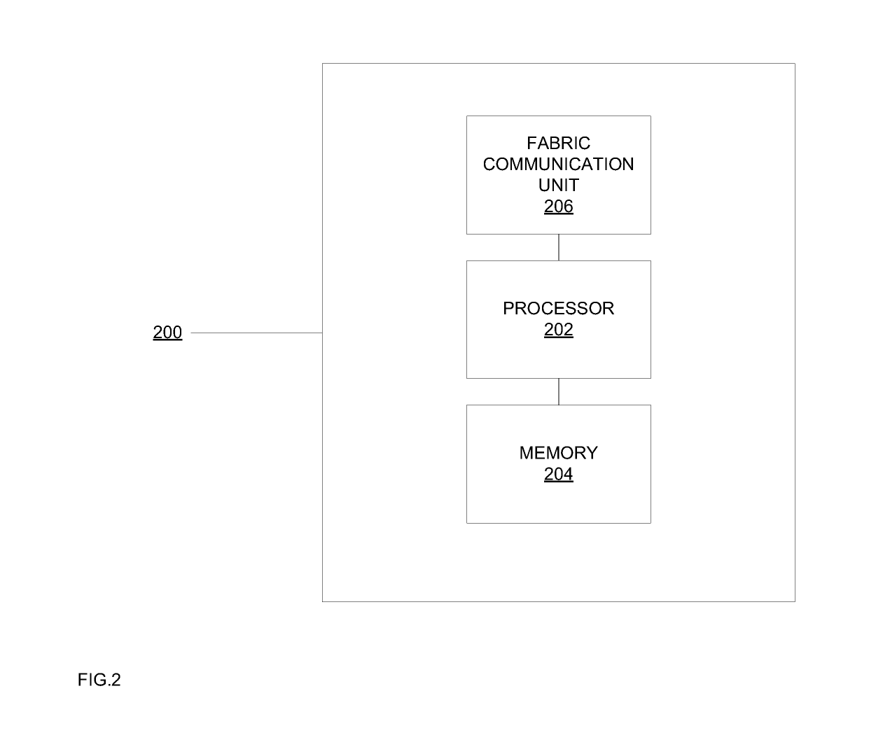

FIG. 2 shows an example schematic of a computer according to the present disclosure. Some elements of this figure are described above. Thus, same reference characters identify identical and/or like components described above and any repetitive detailed description thereof will hereinafter be omitted or simplified in order to avoid complication.

A computer 200 comprises a processor 202, a memory 204 operably coupled to the processor 202, and a fabric communication unit 206 operably coupled to the processor 202. The processor 202 includes at least one core. For example, the processor 202 comprises a logic unit, a register, and a cache memory operably interconnected with each other. The memory 204 is flash main memory, but other types of memory are possible, whether alternatively or additionally, in whole or in part, such as non-flash memory. For example, the processor 202 is operably coupled to the memory 204 over a memory bus spanning therebetween. The fabric communication unit 206 comprises at least one of a network card and an adapter. The fabric communication unit 206 is configured to enable data communications between the computer 200 and other computing devices, such as computer servers. For example, the fabric communication unit 206 can be configured to facilitate at least a partial performance of the RDMA technique involving the memory 204 of the computer 200 and a main memory of another computer over the fabric 110, as described above.

At least one of the host device 102, the storage subsystem controller 104, the flash memory storage node device 106, and the flash memory storage node device 108 is configured based at least in part on an architecture of the computer 200. Note that the computer 200 can comprise at least one input device of any type or an at least one output device of any type.

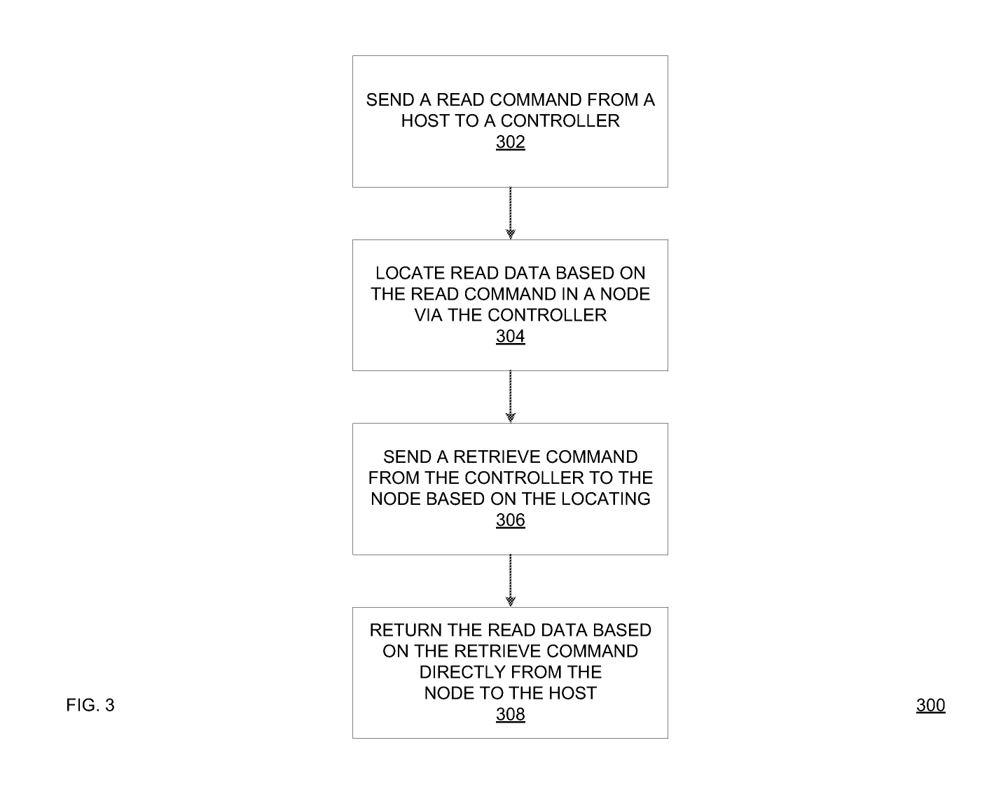

FIG. 3 shows a flowchart of an example embodiment of a method for reading data according to the present disclosure. Some elements of this figure are described above. Thus, same reference characters identify identical and/or like components described above and any repetitive detailed description thereof will hereinafter be omitted or simplified in order to avoid complication.

A method 300 comprises a set of blocks 302-308. The method 300 is used for reading data for any purpose. Process 300 is performed in a sequential numerical order, as shown, but can be performed in a non-sequential numerical order. Process 300 is at least partially performed via a SAN operator. However, whether domestically and/or internationally, process 300 can be at least partially performed, facilitated for performance, and/or assisted in such performance via at least one entity, such as a telecommunication service provider or a cloud computing provider.

In block 302, a host device, such as the host device 102, sends a read command to a controller, such as the controller 104. The read command is sent as a data packet, which can comprise read content address information or any information associated therewith. The sending is over a fabric, such as the fabric 110. The sending is direct, but can be indirect.

In block 304, the controller locates read data based on the read command in a node device, such as the node device 106. The locating is performed over the fabric 110. Such locating is based at least in part on the controller being aware of what data the node device stores in a main memory of the node device. For example, the controller identifies which node device coupled to the fabric stores desired read data in the main memory of the node device. The read data can be of any type, such as a file or a portion thereof. The locating is direct, but can be indirect.

In block 306, the controller sends a retrieve command to the node device based on the locating. The sending is performed over the fabric. The retrieve command is sent as a data packet. The retrieve command is based on the read command, such as via being instructive to retrieve the read data associated with the read command. The retrieve command can comprise an RDMA connection request to perform the read data transfer from the main memory of the node device to a main memory of the host device. Accordingly, based on the sending, the node device receives the retrieve command over the fabric and loads the read data into the main memory of the node device. Stated differently, the controller sets up a third-party RDMA request between the node device and the host device. Alternatively, if the fabric does not allow or is not configured to enable a third-party RDMA request, then the controller can send a command to the node device to perform the transfer. Resultantly, no data copies are required.

In block 308, the node device returns the read data directly to the host device. The return is based on the retrieve command. The return is over the fabric. The return is from the main memory of the node device to the main memory of the host device, without intermediate copies, such as based on the RDMA connection request.

Therefore, by eliminating at least two intermediate copies (flash drive to storage node and storage node to controller), the topology enables reading with lower latency than current flash-based storage subsystems. By using the much higher bandwidth of the main memory bus, rather than the narrow bandwidth of solid-state disk interfaces or the IO bus, the topology enables reading with higher throughput than current flash-based storage subsystems, limited only by the performance of the fabric itself. Also, note that in order to enable flash memory hot swapping, while accommodating for redundancy, mirroring can be performed as a unit of failure is an entire node device rather than an individual solid-state disk drive.

In some embodiments, for reading, the host device can perform at least one of deduplication and compression on the read data based at least in part on the read data being communicated to the host device. For example, whether in-line, such as in real-time, or post-process, the host device compares unique data portions against non-unique data portions and replaces the non-unique data portions with a reference or a pointer referring to or pointing to the unique data portions. Note that such deduplication can occur in a primary storage or a secondary storage. Also, note that the deduplication can be performed via hashing. Further, for example, whether in-line, such as in real-time, or post-process, the host device compresses the read data in any manner. The host device can also perform encryption of the read data based at least in part on at least on the of the deduplication and the compression, such as thereafter. For flash memory specific maintenance issues, the controller can also perform wear leveling of the flash main memory of the node device, although no wear leveling is possible as well, whether in part or in whole. The wear leveling can be dynamic or static. For example, the wear leveling can be checksum or error-correcting code based, pool of reserve space based, or least frequently used block/sector queue based, whether hardware or software implemented.

In some embodiments, for reading, the node device operates the flash main memory, such as RAM, as secondary or auxiliary storage, such as a mass storage disk to which a processor is unable to directly access unless an IO bus is used. One example of such secondary storage is a hard disk drive. Such implementation can used for even faster access of temporary/working files that do not need permanency.

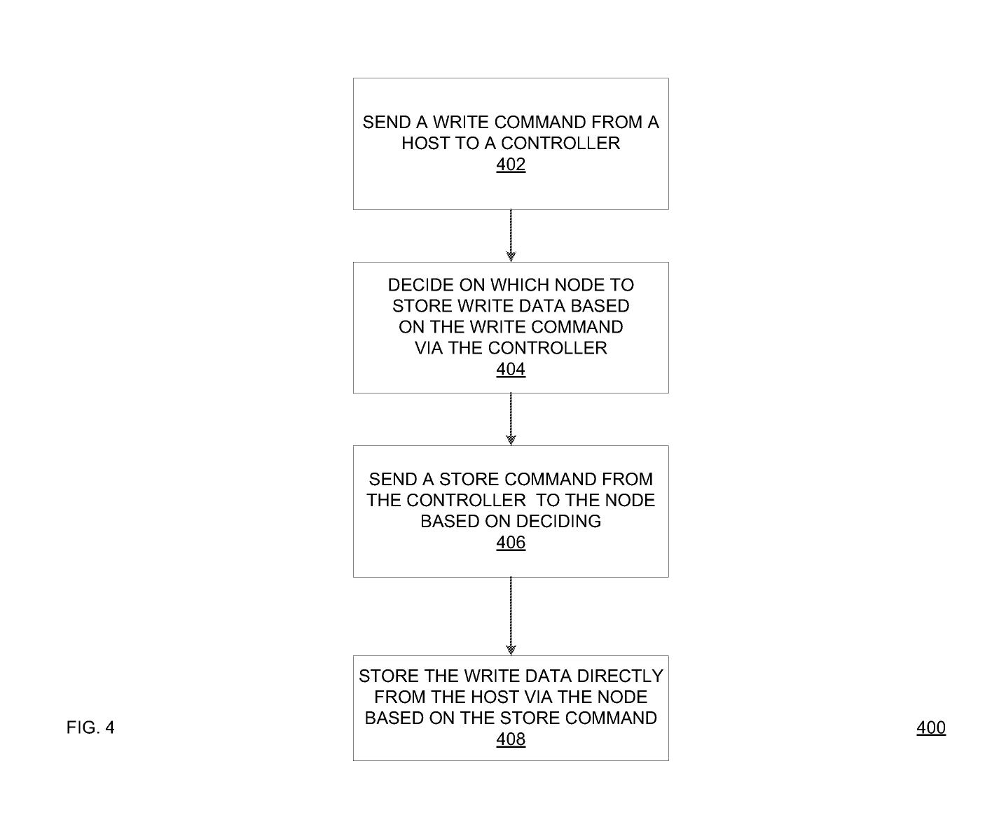

FIG. 4 shows a flowchart of an example embodiment of a method for writing data according to the present disclosure. Some elements of this figure are described above. Thus, same reference characters identify identical and/or like components described above and any repetitive detailed description thereof will hereinafter be omitted or simplified in order to avoid complication.

Process 400 can be performed in a sequential numerical order and/or a non-sequential numerical order. Process 400 is at least partially performed via a SAN operator. However, whether domestically and/or internationally, process 400 can be at least partially performed, facilitated for performance, and/or assisted in such performance via at least one entity, such as a telecommunication service provider or a cloud computing provider.

In block 402, a host device, such as the host device 102, sends a write command to a controller, such as the controller 104. The write command is sent as a data packet, which can include write content or any information associated therewith. The sending is over a fabric, such as the fabric 110. The sending is direct, but can be indirect.

In block 404, the controller identifies on which node device to store write data. The identification is based at least in part on the controller being aware of what node devices are available for data storage and what their main memory storage capabilities are, such as via being aware of main memory storage size, main memory storage type, main memory storage addressing, and so forth. For example, the controller identifies which node device coupled to the fabric can store the write data in its main memory and which location on that main memory will be used to store the write data. The write data can be of any type, such as a file or a portion thereof. The write data is based on the write command.

In block 406, the controller sends a store command to the node device. The sending is over the fabric. The sending is direct, but can be indirect. The sending is based on the identification, such as via being instructive to store the write data associated with the write command. The store command can comprise an RDMA connection request to perform the write data transfer from a main memory of the host device to the main memory of the node device. Accordingly, based on the sending, the node device receives the store command over the fabric and can prepare to receive the write data from the main memory of the node device in the main memory of the node device. Stated differently, the controller sets up a third-party RDMA request between the host device and the node device. Alternatively, if the fabric does not allow or is not configured to enable a third-party RDMA request, then the controller can send a command to the host device to perform the transfer. Resultantly, no data copies are required.

In block 408, the host device sends the write data directly to the node device. The sending is based on the store command. The sending is over the fabric. The sending is from the main memory of the host device to the main memory of the node device, without intermediate copies, such as based on the RDMA connection request. In some embodiments, the write data is written to a plurality of node devices, for redundancy.

Therefore, by eliminating at least two intermediate copies (controller to storage node and storage node to flash drive), the topology enables writing with lower latency than current flash-based storage subsystems. By using the much higher bandwidth of the main memory bus, rather than the narrow bandwidth of solid-state disk interfaces or the IO bus, the topology enables writing with higher throughput than current flash-based storage subsystems, limited only by the performance of the fabric itself. Also, note that in order to enable flash memory hot swapping, while accommodating for redundancy, mirroring can be performed as a unit of failure is an entire node device rather than an individual solid-state disk drive.

In some embodiments, for writing, because the controller does not see the write data, the host device can perform at least one of deduplication and compression on the read data based at least in part on the write data being communicated to the node device. For example, whether in-line, such as in real-time, or post-process, the host device compares unique data portions against non-unique data portions and replaces the non-unique data portions with a reference or a pointer referring to or pointing to the unique data portions. Note that such deduplication can occur in a primary storage or a secondary storage. Also, note that the deduplication can be performed via hashing. Further, for example, whether in-line, such as in real-time, or post-process, the host device compresses the read data in any manner. The host device can also perform encryption of the read data based at least in part on at least on the of the deduplication and the compression, such as thereafter. For flash memory specific maintenance issues, the controller can also perform wear leveling of the flash main memory of the node device, such as in block 404, although no wear leveling is possible as well, whether in part or in whole. The wear leveling can be dynamic or static. For example, the wear leveling can be checksum or error-correcting code based, pool of reserve space based, or least frequently used block/sector queue based, whether hardware or software implemented.

In some embodiments, for writing, the node device operates the flash main memory, such as RAM, as secondary or auxiliary storage, such as a mass storage disk to which a processor is unable to directly access unless an IO bus is used. One example of such secondary storage is a hard disk drive. Such implementation can used for even faster access of temporary/working files that do not need permanency.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

In some embodiments, an apparatus or system comprise at least one processor, and memory storing instructions that, when executed by the at least one processor, cause the apparatus or system to perform one or more methodological acts as described herein. In some embodiments, the memory stores data, such as one or more structures, metadata, lines, tags, blocks, strings, or other suitable data organizations.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description herein.

As will be appreciated by one skilled in the art, aspects of this disclosure can be embodied as a system, method or computer program product. Accordingly, aspects of the present disclosure can take the form of an entirely hardware embodiment, an entirely software embodiment (including firmware, resident software, micro-code, etc.) or as embodiments combining software and hardware aspects that can all generally be referred to herein as a “circuit,” “module” or “system.” Furthermore, aspects of the disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific example (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device. Program code embodied on a computer readable medium can be transmitted using any appropriate medium, including but not limited to wireless, wireline, optical fiber cable, radiofrequency (RF), etc., or any suitable combination of the foregoing.

Computer program code for carrying out operations for aspects of the present disclosure can be written in any combination of one or more programming language, including an object oriented programming language, such as Java, Smalltalk, C++ or the like and conventional procedural programming language, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The diagrams depicted herein are illustrative. There can be many variations to the diagram or the steps (or operations) described therein without departing from the spirit of the disclosure. For instance, the steps can be performed in a differing order or steps can be added, deleted or modified. All of these variations are considered a part of the disclosure.

The description of the present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated. It will be understood that those skilled in the art, both now and in the future, can make various improvements and enhancements which fall within the scope of the claims which follow.

What is claimed is:

1. A method for reading data, the method comprising:
receiving, via a storage subsystem controller, over a fabric, a read command from a host device;
locating, via the storage subsystem controller, over the fabric, based at least in part on the read command, read data in a flash main memory of a node device; and
facilitating, via the storage subsystem controller, an establishment of a remote direct memory access connection between the flash main memory of the node device and the host device over the fabric such that the read data is communicable from the flash main memory of the node device to the host device over the fabric.

2. The method of claim 1, further comprising:
communicating the read data from the flash main memory of the node device to the host device over the fabric based at least in part on the remote direct memory access connection.

3. The method of claim 2, further comprising:
performing, via the host device, at least one of deduplication and compression on the read data based at least in part on the communicating.

4. The method of claim 3, further comprising:
encrypting, via the host device, the read data based at least in part on at least on the of the deduplication and the compression.

5. The method of claim 1, wherein the fabric is at least partially InfiniBand® specification based.

6. The method of claim 1, further comprising:
wear leveling, via the storage subsystem controller, the flash main memory of the node device.

7. The method of claim 1, wherein the node device operates the flash main memory as secondary storage.

8. A system for reading data, the system comprising:
a fabric;
a host device operably coupled to the fabric;
a storage subsystem controller operably coupled to the fabric, wherein the storage subsystem controller is configured to receive a read command from the host device over the fabric; and
a node device comprising a flash main memory, wherein the node device is operably coupled to the fabric, wherein the storage subsystem controller is configured to locate read data in the flash main memory of the node device over the fabric based at least in part on the read command, wherein the storage subsystem controller is configured to facilitate an establishment of a remote direct memory access connection between the flash main memory of the node device and the host device over the fabric such that the read data is communicated from the flash main memory of the node device to the host device over the fabric.

9. The system of claim 8, wherein the host device is configured to perform at least one of deduplication and compression on the read data based at least in part on the host device receiving the read data from the flash main memory.

10. The system of claim 9, wherein the host device is configured to encrypt the read data based at least in part on at least on the of the deduplication and the compression.

11. The system of claim 8, wherein the fabric is at least partially InfiniBand® specification based.

12. The system of claim 8, wherein the storage subsystem controller is configured to wear level the flash main memory of the node device.

13. The system of claim 8, wherein the node device operates the flash main memory as secondary storage.

14. A computer readable storage device storing a set of instructions executable via a processing circuit to implement a method of reading data, wherein the method comprises:
receiving, via a storage subsystem controller, over a fabric, a read command from a host device;
locating, via the storage subsystem controller, over the fabric, based at least in part on the read command, read data in a flash main memory of a node device; and
facilitating, via the storage subsystem controller, an establishment of a remote direct memory access connection between the flash main memory of the node device and the host device over the fabric such that the read data is communicable from the flash main memory of the node device to the host device over the fabric.

15. The computer readable storage device of claim 14, wherein the method further comprises:
communicating the read data from the flash main memory of the node device to the host device over the fabric based at least in part on the remote direct memory access connection.

16. The computer readable storage device of claim 15, wherein the method further comprises:
performing, via the host device, at least one of deduplication and compression on the read data based at least in part on the communicating.

17. The computer readable storage device of claim 16, wherein the method further comprises:
encrypting, via the host device, the read data based at least in part on at least on the of the deduplication and the compression.

18. The computer readable storage device of claim 14, wherein the fabric is at least partially InfiniBand® specification based.

19. The computer readable storage device of claim 14, wherein the method further comprises:
wear leveling, via the storage subsystem controller, the flash main memory of the node device.

20. The computer readable storage device of claim 14, wherein the node device operates the flash main memory as secondary storage.
